(19) United States
(12) Patent Application Publication
(10) Pub. No.: US 2026/0169704 A1
(43) Pub. Date: Jun. 18, 2026

(54) METHOD FOR CONVERTING MULTIPLE SCHEDULING SETTINGS OF DIRECTED ACYCLIC GRAPH OF PROGRAMMING MODEL INTO PROGRAM CODE WITH AID OF GRAPHICAL USER INTERFACE

(71) Applicant: MEDIATEK INC., Hsinchu City (TW)

(72) Inventors: Hong-Sheng Zheng, Hsinchu City (TW); Wei-Liang Kuo, Hsinchu City (TW); Ping-Hsun Hsieh, Hsinchu City (TW)

(73) Assignee: MEDIATEK INC., Hsinchu City (TW)

(21) Appl. No.: 18/981,656

(22) Filed: Dec. 16, 2024

(51) Int. Cl. G06F 8/35; G06F 3/048; G06F 8/40

(52) U.S. Cl. CPC G06F 8/35; G06F 3/048; G06F 8/40

(57) ABSTRACT

A method for converting multiple scheduling settings of a directed acyclic graph (DAG) of a programming model into a program code with aid of a graphical user interface (GUI) includes: displaying the DAG via the GUI; receiving a user input via the GUI, wherein the user input comprises scheduling information associated with the multiple scheduling settings; and converting the multiple scheduling settings into the program code according to the scheduling information.

### BACKGROUND

The present invention is related to machine learning, and more particularly, to a method for converting scheduling settings of a directed acyclic graph (DAG) of a programming model into a program code with aid of a graphical user interface (GUI).

A DAG is a part of an Artificial Intelligence (AI) model, and is arranged to describe a sequence of execution steps in the complex non-recurring computation. For a user who does not have in-depth knowledge of a programming model, the process of generating optimized input to the programming model according to the DAG may be quite difficult and time-consuming. In addition, for different programming models, the user needs to generate different corresponding directives based on the DAG, which results in reduced design flexibility.

### SUMMARY

It is therefore one of the objectives of the present invention to provide a method for scheduling settings of a DAG of a programming model into a program code with aid of a GUI, and an associated non-transitory machine-readable medium, in order to address the above-mentioned issues.

According to an embodiment of the present invention, a method for converting multiple scheduling settings of a DAG of a programming model into a program code with aid of a GUI is provided. The method comprises: displaying the DAG via the GUI; receiving a user input via the GUI, wherein the user input comprises scheduling information associated with the multiple scheduling settings; and converting the multiple scheduling settings into the program code according to the scheduling information.

According to an embodiment of the present invention, a non-transitory machine-readable medium for storing a first program code is provided. When loaded and executed by a processor, the first program code instructs the processor to execute perform a method for converting multiple scheduling settings of a DAG of a programming model into a second program code with aid of a graphical user interface GUI. The method comprises: displaying the DAG via the GUI; receiving a user input via the GUI, wherein the user input comprises scheduling information associated with the multiple scheduling settings; and converting the multiple scheduling settings into the program code according to the scheduling information.

One of the benefits of the present invention is that, even if a user does not have in-depth knowledge, the user can still intuitively perform a DAG scheduling operation by inputting a user input into the GUI. The processor can automatically convert scheduling information indicated by the user input into a domain-specific language (DSL) code, and then adaptively transform the DSL code into an intermediate representation (IR), which greatly improves cross-platform flexibility and user experience. In addition, the DAG scheduling operation implemented on the GUI can accurately control the number of fusion groups, a tiling size of each fusion group, and a core assignment of each fusion group, in order to optimize processor performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an example of a control scheme of a DAG scheduling operation implemented on a GUI according to an embodiment of the present invention.

FIG. 3 is a flow chart of a method for converting multiple scheduling settings of a DAG of a programming model into a program code with aid of a GUI according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

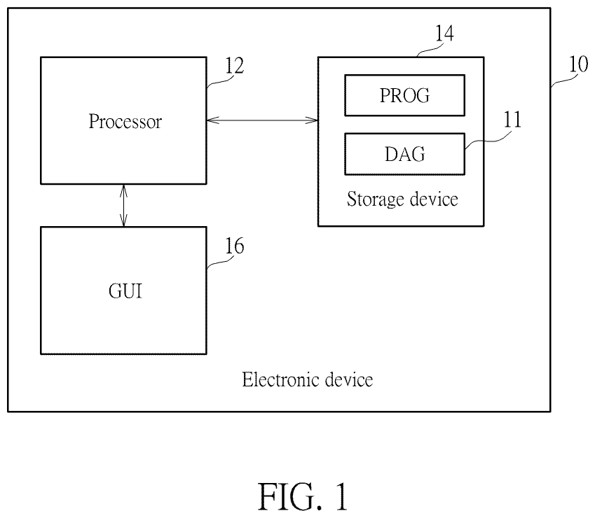

FIG. 1 is a diagram illustrating an electronic device 10 according to an embodiment of the present invention. By way of example, but not limitation, the electronic device 10 may be a tablet computer or a personal computer (e.g., a desktop computer and a laptop computer). The electronic device 10 may include a processor 12 and a storage device 14 (e.g., a memory). The processor 12 may be a single-core processor or a multi-core processor. The storage device 14 is a non-transitory machine-readable medium, and is arranged to store a computer program code PROG and a directed acyclic graph (DAG) 11 of a programming model. Examples of the programming model may include, but are not limited to: a C language model, a C++ language model, a Halide model, and a TVM model. The DAG 11 may be composed of multiple nodes and multiple edges, wherein each node may be a computing unit (or an operation, such as a rectified linear unit 6(ReLU 6 ) operation or a two-dimensional (2D) convolution layer (Conv2D) operation), and each edge may indicate a data flow between two of the nodes.

The processor 12 is equipped with software execution capability. When loaded and executed by the processor 12, the computer program code PROG instructs the processor 12 to execute a graphical user interface (GUI) 16, and perform a method for converting multiple scheduling settings of the DAG 11 into a program code with aid of the GUI 16, wherein the program code may be a domain-specific language (DSL) code. The electronic device 10 may be regarded as a computer system using a computer program product that includes a computer-readable medium containing the computer program code PROG. Regarding the method as proposed by the present invention, it may be embodied on the electronic device 10.

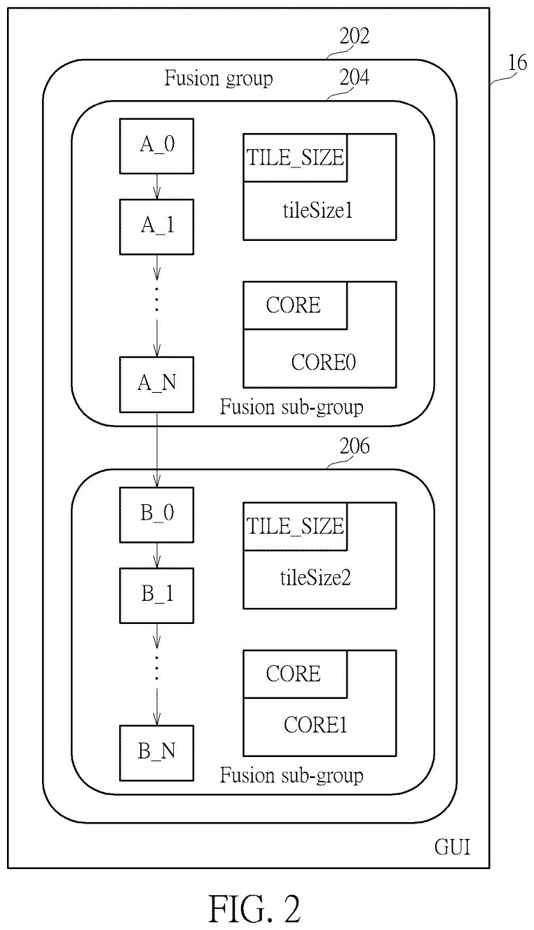

In order to improve the performance of the processor 12 running the programming model, the DAG 11 of the programming model may be optimized, and more particularly, a DAG scheduling operation may be performed upon the DAG 11, wherein the DAG scheduling operation may include at least one of a fusion grouping operation, a tiling operation, and a core assignment operation. In this embodiment, the DAG scheduling operation may be directly implemented on the GUI 16. For example, the DAG 11 may be displayed to a user via the GUI 16, and the user may interact with the GUI 16 for performing the DAG scheduling operation. More particularly, after the interaction between the user and the GUI 16 is completed, a user input USER_IN including scheduling information associated with multiple DAG scheduling settings may be received via the GUI 16, and the processor 12 may then convert the DAG scheduling settings into the DSL code according to the scheduling information, wherein the DAG scheduling settings may include at least one of the number of fusion groups, a tiling size of each fusion group, and a core assignment of each fusion group. Specifically, refer to FIG. 2. FIG. 2 is a diagram illustrating an example of a control scheme of a DAG scheduling operation implemented on the GUI 16 according to an embodiment of the present invention. Assume that the DAG 11 includes multiple nodes A_0-A_N and B_0-B_M, and an arrow between two nodes may represent an edge (i.e., a data flow between the two nodes), wherein both “N” and “M” are integers greater than one (i.e., N>0 and M>0).

According to the scheduling information, the fusion grouping operation may be performed upon the nodes in order to generate multiple fusion groups. Specifically, the user may directly group the nodes to be grouped into the fusion groups on the GUI 16 through the user input USER_IN, wherein the nodes in the same fusion group may be executed together, which can enable data exchange/transmission for the same fusion group to be performed under the same memory hierarchy. In this embodiment, via the user input USER_IN, the nodes A_0-A_N and B_0-B_M may be grouped into a fusion group 202, the nodes A_0-A_N may be further grouped into a fusion sub-group 204, and the nodes B_0-B_M may be further grouped into a fusion sub-group 206 (i.e., the fusion group 202 includes the fusion sub-groups 204 and 206).

For the tiling operation, after the fusion grouping operation is performed, a tiling size of each fusion group may be set according to the scheduling information. For example, the user may directly set the tiling size of each fusion group by inputting the user input USER_IN into a corresponding region of the GUI 16 (labeled as “TILE_SIZE” in FIG. 2). In this embodiment, a tiling size of the fusion group 202 may be set as tileSize 0, a tiling size of the fusion sub-group 204 may be set as tileSize 1, and a tiling size of the fusion sub-group 206 may be set as tileSize2.

Under a situation that the processor 12 is a multi-core processor (e.g., the processor 12 has multiple cores CORE0 and CORE1), the core assignment operation may be performed via the scheduling information and the GUI 16 in order to determine which core each fusion group will run on. For example, the user may directly assign each fusion group to at least one core among the cores CORE0 and CORE1 for running by inputting the user input USER_IN into a corresponding region of the GUI 16 (labeled as “CORE” in FIG. 2). In this embodiment, the fusion sub-group 204 may be assigned to the core CORE0, and the fusion sub-group 206 may be assigned to the core CORE1.

After the above-mentioned DAG scheduling operation is completed, the processor 12 may automatically convert the DAG scheduling settings into the DSL code as follows.

```
  scheduleScope\dot{0}.tile(tileSize\dot{0},
    scheduleScope1.tile(tileSize1,
                  from = A_\dot{0},
                  to = A_N
    ),
    scheduleScope2.tile(tileSize2,
                  from = B_\dot{0},
                  to = B_M
    )
  )
```

In the DSL code, the fusion group 202 is defined as scheduleScope0 with the tiling size of tileSize0, and includes the fusion sub-groups 204 and 206. The fusion sub-group 204 is defined as scheduleScope1 with the tiling size of tileSize1, and a position of the fusion sub-group 204 is from the node A_0 to the node A_N. The fusion sub-group 206 is defined as scheduleScope2 with the tiling size of tileSize2, and a position of the fusion sub-group 206 is from the node B_0 to the node B_M. It should be noted that, the DSL code may be applicable to different programming models, and the processor 12 may be further arranged to adaptively transform the DSL code into an intermediate representation (IR). The IR transformation may be target-dependent. For example, the processor 12 may perform the IR transformation according to a type of the programming model running on the processor 12. Under a situation that the Halide model runs on the processor 12, the processor 12 may adaptively transform the DSL code into directives corresponding to the Halide model.

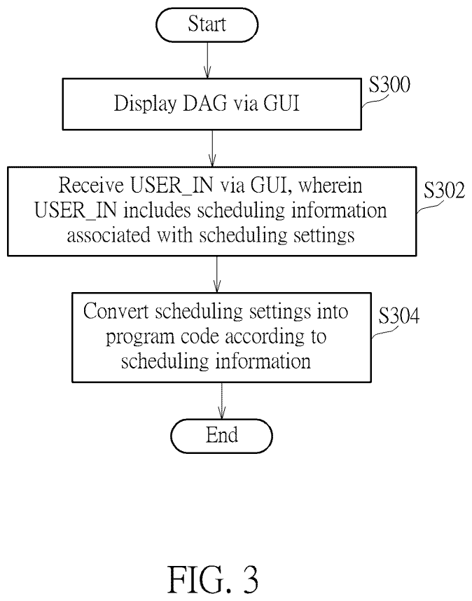

FIG. 3 is a flow chart of a method for converting multiple scheduling settings of the DAG 11 of a programming model into a program code with aid of the GUI 16 according to an embodiment of the present invention. Provided that the result is substantially the same, the steps are not required to be executed in the exact order shown in FIG. 3. For example, the method shown in FIG. 3 may be employed by the processor 12 shown in FIG. 1.

In Step S300, the DAG 11 is displayed via the GUI 16.

In Step S302, the user input USER_IN is received via the GUI 16, wherein the user input USER_IN includes scheduling information associated with the scheduling settings.

In Step S304, the scheduling settings are converted into a program code (e.g., a DSL code) according to the scheduling information.

Since a person skilled in the pertinent art can readily understand details of the steps after reading above paragraphs directed to the processor 12 shown in FIG. 1, further descriptions are omitted here for brevity.

In summary, by the method of the present invention, even if a user does not have in-depth knowledge, the user can still intuitively perform a DAG scheduling operation by inputting a user input into the GUI. The processor can automatically convert scheduling information indicated by the user input into a DSL code, and then adaptively transform the DSL code into an IR, which greatly improves cross-platform flexibility and user experience. In addition, the DAG scheduling operation implemented on the GUI can accurately control the number of fusion groups, a tiling size of each fusion group, and a core assignment of each fusion group, in order to optimize processor performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for converting multiple scheduling settings of a directed acyclic graph (DAG) of a programming model into a program code with aid of a graphical user interface (GUI), comprising:
displaying the DAG via the GUI;
receiving a user input via the GUI, wherein the user input comprises scheduling information associated with the multiple scheduling settings; and
converting the multiple scheduling settings into the program code according to the scheduling information.

2. The method of claim 1, wherein the program code is a domain-specific language (DSL) code.

3. The method of claim 1, wherein the DAG comprises multiple nodes, and the step of receiving the user input via the GUI further comprises:
according to the scheduling information, performing a fusion grouping operation upon the multiple nodes in order to generate multiple fusion groups.

4. The method of claim 3, wherein each node among the multiple nodes is a computing unit.

5. The method of claim 3, wherein the DAG further comprises multiple edges, and each of the multiple edges indicates a data flow between two of the multiple nodes.

6. The method of claim 3, further comprising:
according to the scheduling information, setting a tiling size of each fusion group among the multiple fusion groups.

7. The method of claim 3, wherein the programming model runs on a processor, the processor comprises multiple cores, and the method further comprises:
according to the scheduling information, assigning each of the multiple fusion groups to at least one core among the multiple cores for running.

8. The method of claim 1, further comprising:
adaptively transforming the program code into an intermediate representation.

9. A non-transitory machine-readable medium for storing a first program code, wherein when loaded and executed by a processor, the first program code instructs the processor to execute perform a method for converting multiple scheduling settings of a directed acyclic graph (DAG) of a programming model into a second program code with aid of a graphical user interface (GUI), and the method comprises:
displaying the DAG via the GUI;
receiving a user input via the GUI, wherein the user input comprises scheduling information associated with the multiple scheduling settings; and
converting the multiple scheduling settings into the second program code according to the scheduling information.

10. The non-transitory machine-readable medium of claim 9, wherein the second program code is a domain-specific language (DSL) code.

11. The non-transitory machine-readable medium of claim 9, wherein the DAG comprises multiple nodes, and the step of receiving the user input via the GUI further comprises:
according to the scheduling information, performing a fusion grouping operation upon the multiple nodes in order to generate multiple fusion groups.

12. The non-transitory machine-readable medium of claim 11, wherein each node among the multiple nodes is a computing unit.

13. The non-transitory machine-readable medium of claim 11, wherein the DAG further comprises multiple edges, and each of the multiple edges indicates a data flow between two of the multiple nodes.

14. The non-transitory machine-readable medium of claim 11, wherein the method further comprises:
according to the scheduling information, setting a tiling size of each fusion group among the multiple fusion groups.

15. The non-transitory machine-readable medium of claim 11, wherein the programming model runs on the processor, the processor comprises multiple cores, and the method further comprises:
according to the scheduling information, assigning each of the multiple fusion groups to at least one core among the multiple cores for running.

16. The non-transitory machine-readable medium of claim 9, wherein the method further comprises:
adaptively transforming the second program code into an intermediate representation.
